(19) United States
(12) Patent Application Publication
(10) Pub. No.: US 2003/0100375 A1
(43) Pub. Date: May 29, 2003

(54) Video game system and method having item capable of play based on user-specific password

(76) Inventors: Makoto Wakae, Kyoto (JP); Katsuyta Eguchi, Kyoto (JP)

Correspondence Address: NIXON & VANDERHYE P.C., 1100 North Glebe Road, 8th Floor, Arlington, VA, 22201, US

(21) Appl. No.: 10/225,480

(22) Filed: Aug. 22, 2002

Related U.S. Application Data
(60) Provisional application No. 60/383,798, filed on May 30, 2002.
(60) Provisional application No. 60/384,115, filed on May 31, 2002.

(30) Foreign Application Priority Data
Nov. 27, 2001 (JP) 2001-361690

(51) Int. Cl. A63F 13/00

(52) U.S. Cl. 463/43

(57) ABSTRACT

A game system increases game play interest by making it possible for a player to acquire an item that cannot be acquired in the course of ordinary primary game play. An item acquisition information generating device is provided separately from a game device. The player inputs a code specifying the player in the item acquisition information generating device which then creates a player-specific password from item acquisition parameter data and the received player-specific code, and reports this to the player. The player inputs the reported player-specific password into the game device. The game device decodes this and separates the player-specific code from the item parameter data. The game device verifies the player-specific code, and if the result satisfies a predetermined relationship, it additionally processes the item parameter data. If the item parameter data includes winning probability data, the game device decides whether or not the player wins. If the player wins, it becomes possible to access an item stored in a special item storage unit.

### CROSS-REFERENCES TO RELATED APPLICATIONS

This application claims the benefit of U.S. Provisional Application No. 60/383,798 filed May 30, 2002 and U.S. Provisional Application No. 60/384,115 filed May 31, 2002 and Japan Application No. 2001-361690 filed Nov. 27, 2001, the contents of which are incorporated herein by reference.

### BACKGROUND OF THE INVENTION

1. Field of the Invention

The present invention relates to a video game system and method which are capable of play based on item acquisition information. Specifically, the present invention relates to the type of video game in which an item(s) may be acquired during video game play or in which different game-play parameters (e.g., difficulty modes, characters such as racing cars, and environments in which characters are placed) may be chosen by a user for play in the video game based on input of appropriate item acquisition information. The present invention increases game play interest by making it possible to acquire an item(s) or to select a game-play parameter that cannot be acquired or selected (or is difficult to be acquired or selected) in the normal course of playing a primary game by a method other than game play.

2. Description of Related Art

In one type of video game, a player controls a character which acquires various items such as tools and weapons and the like while the character advances through the game. After acquiring such items, the player may enjoy utilizing them in subsequent game play. Examples of this type of video games include role playing games (RPG). In such RPGs, a player may, for example, battle an enemy and acquire an item from the defeated enemy, or acquire an item by purchasing it at a store using money earned during the game.

Nevertheless, acquiring items in these conventional types of games must be performed during primary (normal) game play, and typically all of the players playing the same game can acquire the same item. It is therefore not possible to acquire an item according to a player's own desires through a method other than primary game play. Also, from the standpoint of video game providers, it is not possible to provide additional value after the customer purchases the game software. For example, it is not possible to allow players to possibly obtain or acquire a new item once a customer has purchased the game software. Accordingly, when a player becomes bored with primary game play, he/she loses interest in that game and it thus becomes difficult to play the same game software for an extended period of time.

### BRIEF SUMMARY OF THE INVENTION

Therefore, the present invention provides a game system capable of play based on user-specific item acquisition information whereby a player can acquire special item(s) or game-play parameter(s) that he/she cannot acquire (or have difficulty in acquiring) in primary game play and can thus play and enjoy the same video game software for a long time.

By providing a player with user-specific item acquisition information, a video game provider who developed and sold the game software can provide additional value to the game even after the game is purchased. New interest in the same game is thus provided to the player even after its original sale.

Since use of the special item(s) or game-play parameter(s) may be based on user-specific item acquisition information which must first be obtained by the player, the present invention enables easy implementation of an event or plan for awarding special items or performing advertising and promotion. For example, players may be instructed to access a certain web site over the internet to obtain the user-specific item acquisition information and thus view any advertising or promotions on the web site. Value can thus be increased with the same game software even after sale, and, thus may be useful for encouraging sale of the game software.

Since the item acquisition information for acquiring a special item or game-play parameter is user-specific (such as a password or code, etc. corresponding specifically to a particular player), if a different player (i.e., a player having a different username) attempts to acquire the special item or game-play parameter for game play using the same item acquisition information (i.e., the item acquisition information based on another's user name), he/she will be unsuccessful.

A winning probability may be provided when awarding item acquisition information. The thrill or speculative spirit of acquiring a special item or game-play parameter is increased by creating a situation where acquiring a special item or game-play parameter is unpredictable.

In an exemplary embodiment of the present invention, a game system capable of play based on item acquisition information comprises a game device including a controller operated by a player, a data storage memory, a game processor, a display for displaying a screen according to image data processed by the game processor. The game system further comprises an item acquisition information generating device separately provided from the game device for generating item acquisition information in accordance with player operation. The data storage memory included in the game device comprises a player-specific data storage unit, an item acquisition information storage unit, a decoding program storage unit, a game program storage unit, and a comparison program storage unit. The item acquisition information generating device comprises an input device for inputting player-specific data and an item acquisition information creating device.

The player-specific data storage unit of the data storage stores data specifying the relevant player when the controller is operated in a predetermined operational sequence by a player. The item acquisition information storage unit stores item acquisition information. The decoding program storage unit stores a decoding program for decoding the item acquisition information. The game program storage unit stores a game program. The comparison program storage unit stores a comparison program. The input device of the item acquisition information generating device inputs player-specific data according to player operation. The item acquisition information creating device creates item acquisition information based on player-specific data received by the input and item acquisition parameter data and reports it to the player.

The game processor included in the game device stores item acquisition information in a storage memory based on the game program when item acquisition information is input by operation of the controller, processes the item acquisition information stored in the storage memory based on the decoding program and decodes it to player-specific data and data other than player-specific data, compares and checks player-specific data stored in the player-specific data storage unit and decoded player-specific data based on the comparison program, and processes so as to allow acquisition of a special item or game parameter associated with the item acquisition information when executing the game program, based on data other than the decoded player-specific data, when the result of the comparison and checking satisfies a predetermined relationship.

The item acquisition information generating device may comprise a server installed in a place separate from a terminal device operated by the player and connected to the terminal device via a communication circuit. This server temporarily stores the relevant player-specific data in a second temporary storage memory when the player inputs the player-specific data through the input at the terminal device side. Also, after the item acquisition information creating device creates item acquisition information based on the player-specific data stored in the second temporary storage memory and the predetermined item acquisition parameter data, the server sends the relevant item acquisition information to the terminal device and reports or notifies it to the player at the terminal device side by a display or sound, etc.

The item acquisition information generating device may alternatively or additionally comprise an external information storage medium associatively provided near the game device, a data reader for reading data recorded or stored on the external information storage medium, and a display. The external information storage medium records or stores the aforesaid item acquisition parameter data. The item acquisition information creating means creates item acquisition information based on player-specific data stored in the second temporary storage memory and item acquisition parameter data read from the external information storage medium by the data reader and reports it to a player by displaying it on the display.

The item acquisition information creating device may create item acquisition information using preset item award probability data as item acquisition parameter data. Item award probability data may be preset for each type of a plurality of special items, and the item acquisition information creating device may create item acquisition information including the type of special item awarded and award probability data.

The game program storage unit may store at least data on a plurality of types of items that can be acquired in primary game play and data on at least one special item that cannot be acquired solely through primary game play and that is set so that acquisition is possible based on the item acquisition information. The game program storage unit may also store a preset game program that plays a game using these plurality of items. Also, the item acquisition information creating device creates data for awarding special items and/or game-play parameters that cannot be acquired in primary game play except as realized by the game program through entry of appropriate item acquisition information.

The game program stored in the game program storage unit may be programmed so that special item acquisition does not affect the primary game's game clear parameters.

The present invention results in a game system capable of play based on user-specific item acquisition information in which a player can obtain a special item and/or game play parameter that cannot be obtained or is difficult to obtain in primary game play. The same game software can be played and enjoyed for a long time. Even after a customer purchases a game, the game provider who developed and sold the game software can provide new additional value to the game and provide the customer (player) with new interest in the same game even after sale. An event for awarding a special item or doing advertising and promotion may be easily implemented, and additional value can be created with the same game software even after sale. Sale of the game software is also promoted. Since the item acquisition information such as a password or code, etc. is user-specific (i.e., corresponds to a specific player), if a player attempts to acquire the special item and/or game-play parameter in game play using the item acquisition information which is based on another user's code name, he/she is unsuccessful in acquiring it. If a winning probability is applied when awarding item acquisition information, and the thrill or speculative spirit of acquiring an item game-play parameter is increased by creating a situation where being able to acquire a special item is unpredictable.

In another exemplary embodiment of the invention, a method of enabling user access to an item for play in a video game being processed by a game device comprises receiving an on-line input of a user code in a computer system, generating a user-specific password based on the received user code utilizing the computer system, and reporting the user-specific password utilizing the computer system. The method further comprises receiving, in the game device, an input of a user code and an input of the user-specific password, processing the user code received in the game device and the user-specific password received in the game device, comparing data resulting from the processing of the user code received in the game device and data resulting from the processing of the user-specific password received in the game device, and enabling user access to the item for play in the video game if the data resulting from the processing of the user code received in the game device and the data resulting from the processing of the user-specific password received in the game device satisfy a predetermined relationship. The predetermined relationship may be satisfied only if the user code input on-line, which is used by the computer system to generate the user-specific password received by the game device, matches the user code received by the game device.

Processing the user-specific password received in the game device may include decoding the user-specific password to user code data and data other than user code data, the user code data forming the data to be compared to the data resulting from the processing of the user code received in the game device.

Alternatively, processing the user code received in the game device may include generating code data based on the user code received in the game device, the generated code data forming the data to be compared to the data resulting from the processing of the user-specific password received in the game device. The process for generating the user-specific password based on the on-line input of the user code in the computer system may correspond to a process for processing the user code received in the game device so that predetermined relationship will be satisfied only if the user code received on-line in the computer system is the same as the user code received in the game device.

The user-specific password generated by the computer system may include user code data and item award probability data. The video game may be a racing video game and the item is at least one of a particular racing vehicle, difficulty mode and racing track.

### BRIEF DESCRIPTION OF THE DRAWINGS

These, as well as other advantages of this invention, will be more completely understood and appreciated by careful study of the following more detailed description of the exemplary embodiments of the invention taken in conjunction with the accompanying drawings, in which:

FIG. 1A is perspective view of an exemplary game device constituting part of a game system in accordance with an exemplary embodiment of the present invention;

FIG. 1B is a block diagram of an exemplary storage unit of the game device illustrated in FIG. 1A;

FIG. 2A is a diagram illustrating an exemplary item acquisition information generating device constituting part of the game system in accordance with an exemplary embodiment of the present invention;

FIG. 2B is a block diagram of an exemplary storage unit of the item acquisition information generating device illustrated in FIG. 2B;

FIG. 3 is a diagram, partially in block form, illustrating details of the game device illustrated in FIG. 1A;

FIG. 4 is a diagram, partially in block form, illustrating details of the item acquisition information generating device illustrated in FIG. 2A;

FIGS. 5A-5B are perspective views illustrating another exemplary embodiment of an item acquisition information generating device in accordance with the present invention;

FIGS. 6A-6B are diagrams illustrating exemplary item acquisition information;

FIG. 7 illustrates display screen examples of a game device or terminal of the item acquisition information generating device in accordance with the present invention;

FIG. 8 is a flow chart describing exemplary item acquisition information generation by the item acquisition information generating device;

FIG. 9 is a flow chart illustrating utilizing the item acquisition information to acquire a desired item in a game;

FIG. 10 is a flow chart describing exemplary item acquisition information generation by the item acquisition information generating device for a racing video game; and

FIG. 11 is a flow chart illustrating utilizing the item acquisition information to acquire a desired item in a racing video game.

### DETAILED DESCRIPTION OF THE INVENTION

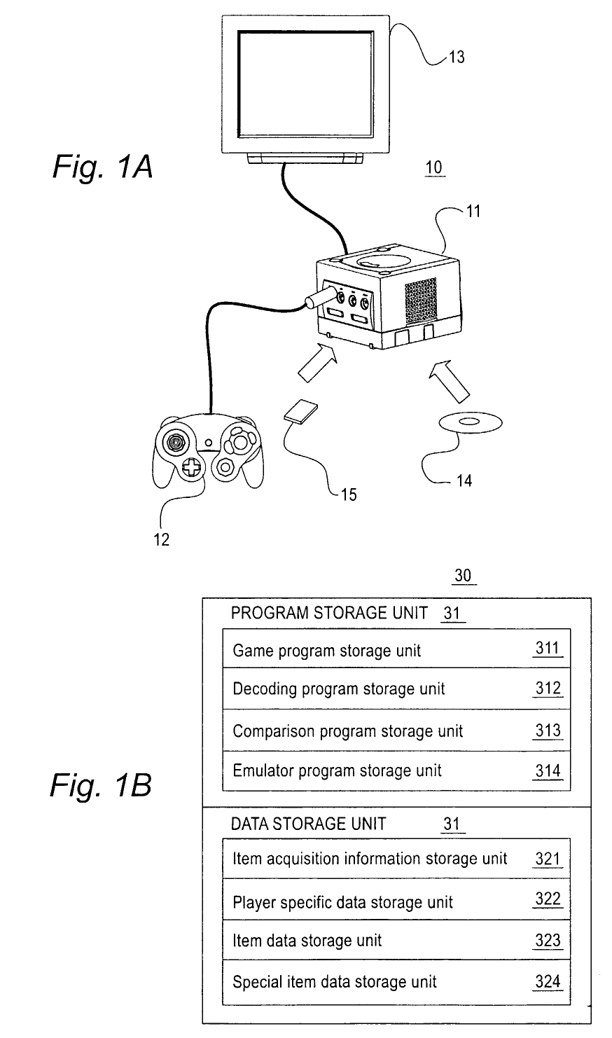

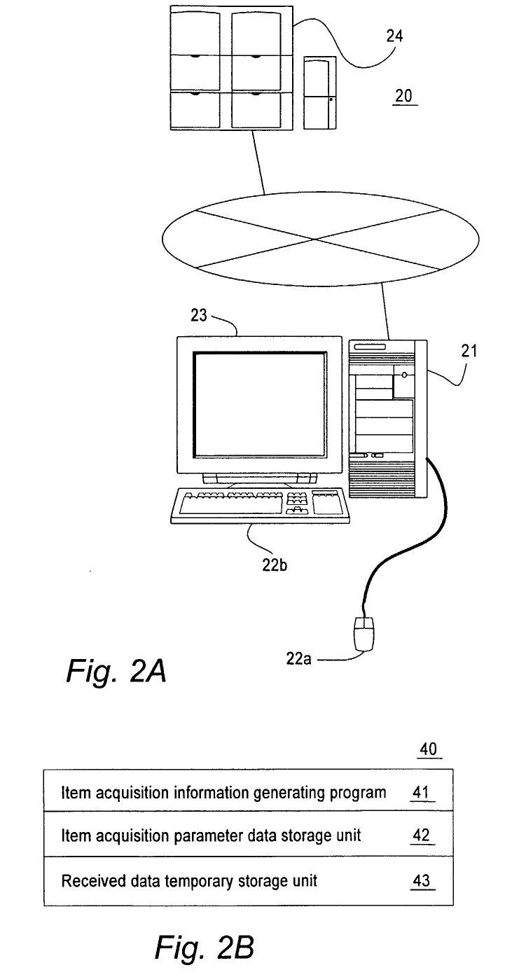

Referring to FIGS. 1-4, a game system in accordance with an exemplary embodiment of the present invention awards a special item such as a tool, weapon, game, food, etc. in a role playing game (RPG) or a difficulty mode, racing vehicle, racing track, etc. in a racing video game to a player after the game software is sold. The game system includes a game device 10 having a game machine main unit 11. A controller 12 operated by a player and a display device (monitor or display) 13 for displaying a game screen are connected to the game machine main unit 11.

A game information storage medium 14 stores information such as a game program, etc., and is removably installed in the game machine main unit 11. Various types of recording or storage media may be used as the game information storage medium 14 (hereinafter simply abbreviated as “storage medium”) such as the following: a ROM cartridge (one dedicated to reading with a built-in ROM only, or one that includes a ROM and is capable of reading and writing with a built-in RAM for storing game progress data), magnetic disk, IC card, optical disk storage medium (including CD-ROM or DVD, etc.), or a magneto-optical disk recording medium, etc. The following explanation discusses the exemplary case in which the game information storage medium 14 is an optical disk. The storage medium 14 stores a game program, decoding program, and comparison program in a fixed manner, and stores an emulator program as required. Furthermore, if the storage medium 14 is a read-only optical disk, etc., it cannot store progress data during a game or backup data, etc., so an external memory 15 with a built-in RAM or flash memory, etc. is removably installed in the game device 10.

A storage unit 30 for storing readable and writable data is built into the game machine main unit 11. A readable and writable memory such as RAM, flash memory, hard disk, etc. is used as the storage unit 30, for example. The storage unit 30 includes a program storage unit 31 for reading and temporarily storing part of the program data stored in the storage medium 14 and a data storage unit 32 for temporarily storing data during a game. The program storage unit 31 includes a storage unit (or storage region) 311 storing a game program, a storage unit 312 storing a decoding program, and a storage unit 313 storing a comparison program. If necessary, program storage unit 31 additionally includes a storage unit 314 for storing an emulator program. The data storage unit 32 includes a storage unit 321 for storing item acquisition information such as a password, etc., a storage unit 322 for storing user-specific data, a storage unit 323 for storing data on items acquired through primary game play, and a storage unit 324 for storing special item data.

In addition, an item acquisition information generating device 20 is provided separately from the game device 10 allowing a player to acquire (or be awarded) special items through a method other than primary game play. The item acquisition information generating device 20 includes a terminal device 21 such as a personal computer, for example, and a server 24 selectively connected via an Internet circuit, etc. A keyboard 22a or mouse 22b or the like for allowing the player to provide input to the terminal device 21, and a display device 23 are connected to the terminal device 21. The display device 23 displays various types of information created or generated by the server 24 and is used for providing a player with item acquisition information.

Here, a special item differs from a tool, weapon, magic, etc. that can be acquired through primary game play preprogrammed into the game software. It is an item whose acquisition does not affect the game clear parameters in the primary game, and is a distinctive item that cannot be obtained or is extremely difficult to obtain in primary game play. For example, in a game whose objective is to capture and collect monsters, etc., it is a character such as a special monster that cannot be captured or is difficult to capture during game play. Or in the case of a role playing game of the sort where one's colleagues increase during game play, the special item is a special character that can only be acquired or obtained through a method other than primary game play, and is a character that is not necessary and indispensable for clearing that game for play. As yet another example, the special item may be a certain difficulty mode, racing vehicle or racing track whose access for game play is relatively difficult to attain (e.g., access for game play is prevented unless certain game-play goals are first met by the player).

A high-capacity storage unit 40 such as a hard disk, etc. is associatively provided at the server 24 side. The storage unit 40 includes storage units (or storage regions) 41-43. The storage unit 41 is configured to store a program for generating or creating item acquisition information. The storage unit 42 stores item acquisition parameter data. For example, storage unit 42 stores data on the types of special items and/or data on the types of special items and probability data that enables one to actually acquire those special items, etc. This item acquisition parameter data may also be code for reading characteristics data (type, ability, performance, etc.) of each type of special item stored in the storage medium 14. The storage unit 43 temporarily stores data sent to and received from the terminal device 21 when a player operates the terminal device 21 and the input player-specification data, etc. is received.

Before starting game play, a player first installs a purchased storage medium 14 containing game software in the game device 10. The player then operates the controller 12 while watching the display of the display device 13 and registers player-specific information such as his own name, alias (nickname or handle name), etc. Player-specific information is temporarily stored in the player-specific data storage unit 322 included in the storage unit 30. When the player starts the game, the CPU (not shown in the drawings) included in the game device 10 reads the program data, etc. needed for game play from the storage medium 14 causing it to be stored in the storage unit 311, and executes the game program. When this occurs, data on items acquired through primary game play is included in the progress data during the game and stored in the storage unit 323. It is impossible to acquire special items in primary game play, or is extremely difficult to acquire special item(s) in primary game play. Also, the program is set so that the game can be cleared (for play) even if special items are not used. Also, if after enjoying game play a player interrupts the game and later wants to continue playing (if the end button is operated or the end command is selected), the player-specific data stored in the storage unit 322 is stored in the external memory 15 and the back up data stored in the external memory 15 may be used the next time the game is played.

If a player wants to acquire a special item that cannot be acquired in primary game play or that is extremely difficult to acquire in primary game play, the special item may be acquired using item acquisition information from the item acquisition information generating device 20. The item acquisition information generating device 20 is separate from the unit for playing the game. For example, if the item acquisition information can be acquired from a home page established by the software game provider, the player may interrupt the game, and operate the input device 22 of terminal device 10 to connect the terminal device 21 to the server 24. Access to the internet home page of the software game provided is granted for obtaining the item acquisition information. Responding to this request, image data for awarding the special item is sent from the server 24 to the terminal device 21 via an Internet connection, and the relevant home page is displayed on the display screen of the display device 23. The player views this home page and inputs a player-specific code such as his name, etc. This player-specific code may be the same as that registered in the game device 10 when game play began, or may be a newly provided code specifying the player during primary game play.

When the server 24 receives the player-specific code, that code is stored in the received data temporary storage unit 43, after which the player-specific code and the item acquisition parameter data (including data on the type of special item and acquisition probability data) are combined, forming the item acquisition information. The item acquisition information is temporarily stored in the storage unit 41, and sent to the terminal device 21. The terminal device 21 displays the received item acquisition information on the screen of display device 23 (home page screen). The player reads the item acquisition information (password or code) displayed on the home page and saves it by making a memo, etc.

The player operates the controller 12 and inputs the acquired item acquisition information into the game machine 11. In response, the game machine 11 temporarily stores the input item acquisition information in the storage unit 321, and decodes the item acquisition information based on the decoding program stored in the decoding program storage unit 33. Here the decoding method is one that breaks it down into the player-specific code included in the item acquisition information and item acquisition parameter data (data on the type of special item and acquisition probability data). The game machine 11 then compares and checks the player-specific code previously registered in the game machine 11 and the decoded player-specific code based on a comparison program stored in the storage unit 33. If the comparison result satisfies a predetermined relationship, the game gives the player an opportunity to acquire an item. If no acquisition probability data is supplied or if the acquisition probability data is 100%, the special item equivalent to the type data is automatically awarded. The awarded special item type data is written into storage unit 324. Furthermore, when the acquisition probability data is less than 100%, processing is performed based on that probability and the special item is awarded according to that acquisition probability. Conversely, if the comparison result does not satisfy the predetermined relationship, the opportunity to acquire the item is invalid.

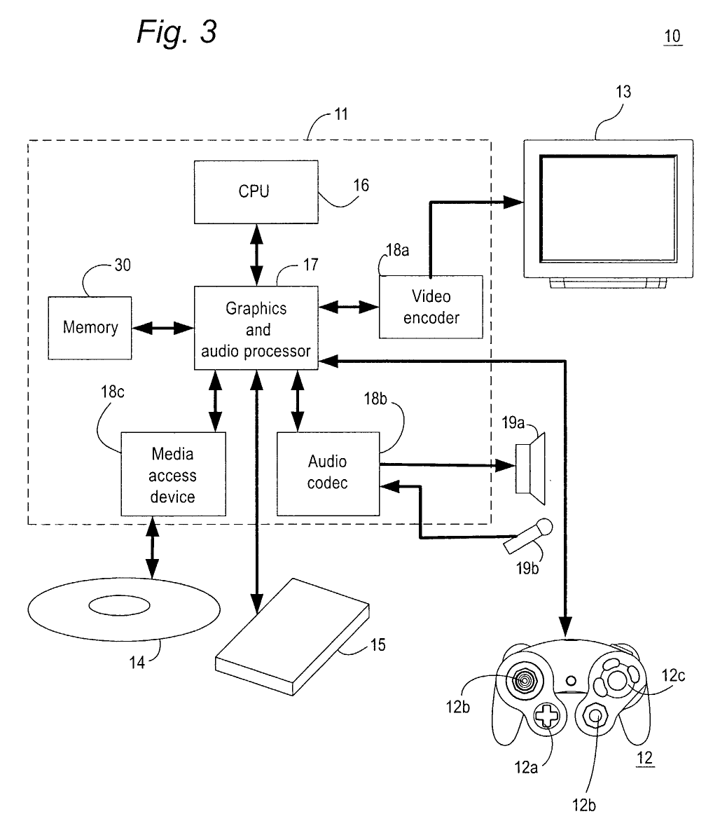

Next, the details of the game machine 11 supporting the present invention shall be explained with reference to FIG. 3. The game machine 11 includes a CPU 16 for processing programs. A graphics and audio processor (hereinafter abbreviated as “G processor”) 17 is connected to the CPU 16. The controller 12, video encoder 18a, audio codec 18b, media access device 18c, and storage unit (memory) 30 are connected to the G processor 17. The display device 13 is connected to the video encoder 18a. An external speaker 19a and an audio input device 19b are connected to the audio codec 18b.

The controller 12 includes a plurality of operation switches 12a and an analog joystick 12b. A direction switch 12a is a digital direction indication switch used to indicate four directions. The analog joystick 12b is an analog pointing device, and is used to input data other than digital data, such as direction indications and camera direction in games that use three-dimensional displays. A movement switch 12c is used to indicate movement other than directional indications.

The video encoder 18a works as an interface based on processed data obtained by the program of CPU 16. When the G processor 17 creates image data, the video encoder 18a converts the relevant image data to an image signal and supplies it to the display device 13, where it is displayed as an image. The audio codec 18b works as an interface based on processed data obtained by the program of CPU 16. Audio data created by the G processor 17 is converted to an analog audio signal and sound is output from the external speaker 19a. The audio codec 18b converts an audio analog signal input from the microphone 19b to a digital signal, transfers it to the G processor 17, and converts it to processable data based on a CPU 16 program. The media access device 18c reads programs and data stored in the storage medium 14 and transfers them to the G processor 17. The G processor 17 transfers received data to the memory 30 and stores it. The CPU 16 accesses the memory 30 via the G processor 17, and reads and executes programs and acquires and writes data, thereby performing program-based game processing.

As required, an external memory (memory card) 15 may additionally be connected to the G processor 17. As explained with reference to FIG. 1A, the memory card 15 has a built-in flash memory and therefore stores and holds game progress data, etc. obtained as the result of the CPU 16 running a program.

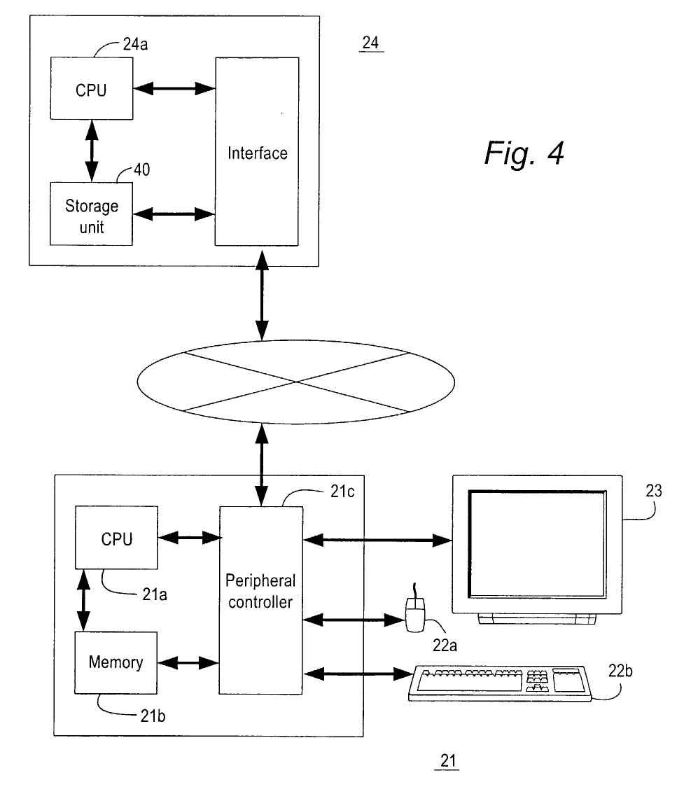

Next, the item acquisition information generating device 20 shall be described in detail with reference to FIG. 4. The item acquisition information generating device 20 includes of a terminal device 21 and server 24. The terminal device 21 uses, for example, a generally known personal computer (hereinafter abbreviated as PC). Specifically, the terminal device 21 includes a terminal CPU 21a. The terminal CPU 21a performs various processing to access data or programs stored in a memory 21b. The terminal CPU 21a processes input information input from the input device 22, which is a mouse 22a or keyboard 22b, etc., via a peripheral controller 21c, according to a program. In addition, the CPU 21a supplies processed information data to the display device 23 via the peripheral controller 21c, to display images. The peripheral controller 21c is connected to a network circuit such as the Internet, etc.

The server 24 includes a server CPU 24a. The server CPU 24a processes and executes programs and data stored in the storage unit 40. Also, the server 24 sends data to and receives data from the terminal device 21 connected via a network. In order to function as part of the item acquisition information device 20, the server 24 stores at least an item acquisition information generating program 41 and item acquisition parameter data 42 in the storage unit 40. When a user-specific code is sent from the terminal device 21, the server 24 stores this in received data temporary storage unit 43. Then the server 24 uses the item acquisition parameter data stored in the storage unit 42 and the received user-specific code stored in the storage unit 43 to create (or generate) item acquisition information based on the item acquisition information generating program.

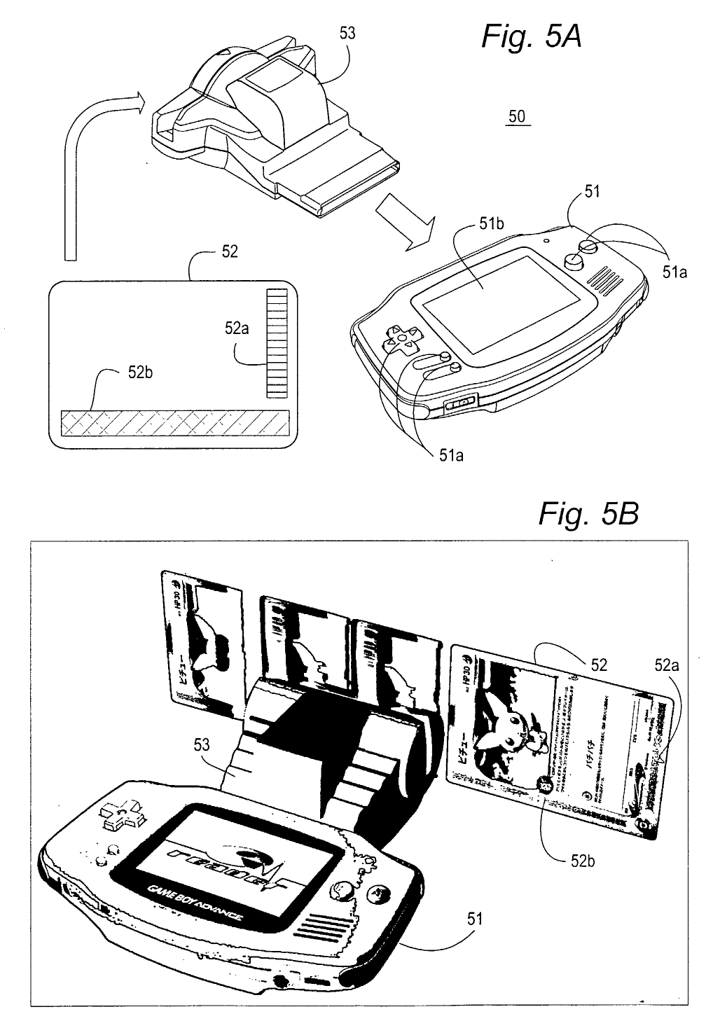

FIGS. 5A-5B are diagrams showing another example of an item acquisition information generating device. The item acquisition information generating device 50 in this embodiment constitutes a portable game machine 51, card 52, and card reader 53, instead of a home page using the Internet. Specifically, the portable game machine 51 has at least operation keys 51a and display 51b installed at one main surface (the front) of the housing. Also, the portable game machine 51 has at least a CPU (not shown in the drawings) and built in memory. The CPU performs processing based on programs stored in the memory. The card reader 53 is a cartridge type optical reader removably installed in the portable game machine 51. The card reader 53 reads two-dimensional bar code data recorded (e.g., printed) on the card 52, converts it to a predetermined data format, and transfers it to the memory inside the portable game machine 51. Also, item acquisition parameter data is recorded on the card 52.

The item acquisition information generating device 50 has an item acquisition information generating program previously stored in the memory (not shown in the drawing) such as a ROM, etc. built into the card reader 53, and the item acquisition parameter data is supplied by the card 52. For example, item acquisition parameter data recorded on the card 52 is read by the card reader 53 and stored in the memory (RAM) of the portable game machine 51. Subsequently, when a player operates keys 51a and inputs a player-specific code, the CPU of the portable game machine 51 combines the player-specific code and item acquisition parameter data based on the item acquisition information generating program, and creates item acquisition information comprising of a password or text or code, etc. This item acquisition information is displayed on the display 51b. Another method of giving or reporting the item acquisition information to the player is audio output. When item acquisition information is made known (or reported) to the player in this manner, the player operates controller 12 of game device 10 and inputs the item acquisition information.

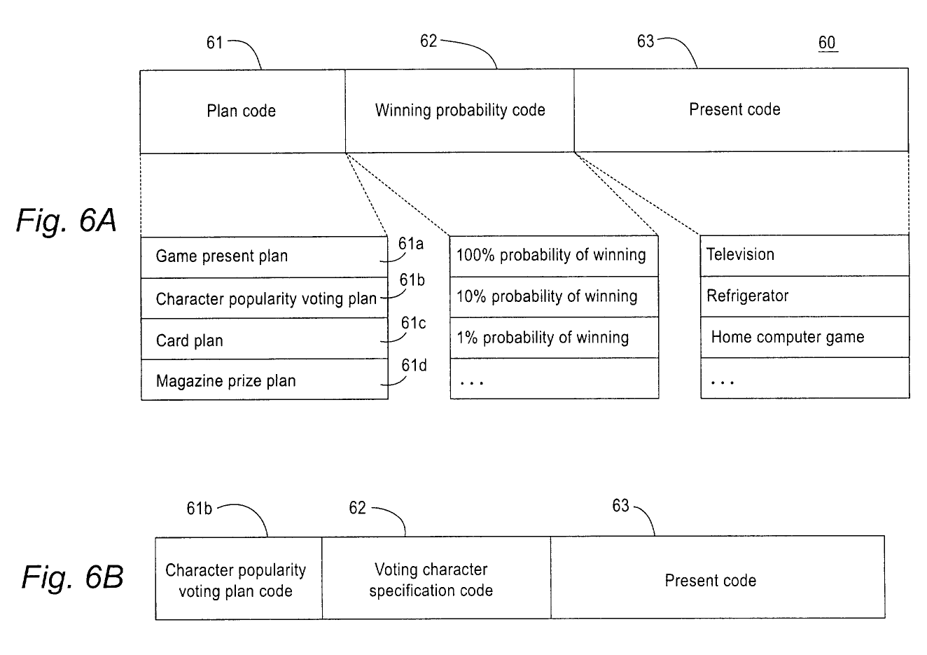

FIGS. 6A-6B are diagrams graphically showing the data structure of item acquisition parameter data. This item acquisition parameter data 60 is basic data used when the item acquisition information generating device 20 or 50 creates item acquisition information, and is also data that the game device 10 decodes based on the decoding program. Specifically, item acquisition parameter data 60 comprises a plan code 61, winning probability data 62, and a present code 63. The plan code 61 identifies the method whereby a player can acquire an item in non-primary game play. For example, a plan code 61a is included in the case of a game present plan, a plan code 61b is used if there is a special item present plan based on voting on character popularity during a game, a plan code 61c is used when the item is acquired using card 52 and information generating device 50, and a plan code 61d is used for item acquisition plans using a medium other than a home page, such as a magazine, etc.

The winning probability code 62 is probability data or a code for indicating if a special item can be acquired and with what probability. However, the winning probability code 62 can also be replaced by equivalent data in other plans. As one example, using an item winning probability is not appropriate in the previously described character popularity voting plan, so it may be replaced with a character code specifying the type of character in popularity voting. The present code 63 is a code for a special item that cannot be acquired (or is extremely difficult to acquire) in primary game play. Image data on the relevant item is stored in the storage medium 14 from the beginning, and the present code 63 is a code for reading special item image data transferred to and stored in the game machine main unit 11's memory 30. These special item codes are prepared in advance in the item acquisition information generating device 20, and the software provider side can prepare various types of data. That is, a plurality of special items that can be acquired in non-primary game play are prepared and stored in advance in the storage medium that a player purchases. When the game provider side holds various types of events, the provider makes it known that it is providing special items. If the types of special items provided at the event site or home page, etc. are different and if the provision period is different, the player can enjoy different game play with the same game software each time he acquires a special item. Pleasure from game play therefore increases and thus an incentive and opportunity is provided to play the same game software for a long time.

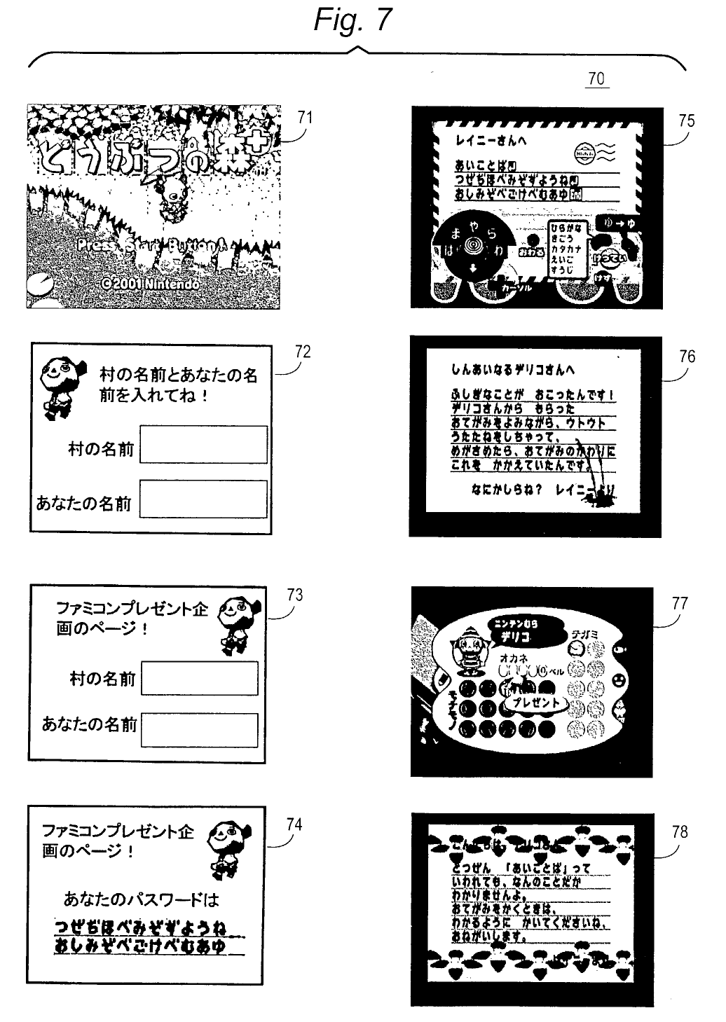

FIG. 7 shows examples of screen displays when obtaining item acquisition information using the game contents of the game device 10 and the item acquisition information generating device 20. In particular, the exemplary screen displays illustrate obtain and entering item acquisition information in a role playing video game which involves virtual world activities. In this game, a player selects a specific character which becomes his/her identity (the protagonist character). The selected character can act freely in this virtual world (virtual town). within the range set by the program under the control of the player. The things needed for life in this town (tools, food, etc.) are all items that can be acquired from virtual stores or through events that occur in the course of daily virtual activities.

In sequence 70, which shows the flow of the game, screen 71 is the game's first screen. Screen 72 shows an example of a screen in this game for inputting the name of the town where virtual activities occur and one's own identity. Meanwhile, the game provider side notifies the player in advance that presentation of items for the relevant game is taking place on the home page. A player notified of the presentation of items uses the item acquisition information generating device 20 in an attempt to acquire or obtain the item acquisition information. Screen 73 is an example of the display screen for a page which is part of the item present plan. Screen 73 is displayed on the display device 23 connected to the terminal device 11. When prompted, the player inputs the name of the town and his identity as the player-specific data into screen 72.

Subsequently, the page shifts to screen 74. Password creation processing is performed based on the player-specific data and item acquisition parameter code, and that password is displayed on the display device 23 at the terminal device 21 side. The item acquisition information password is created by the item acquisition information generating device 20 (or 50) based on item acquisition parameter data 42 and the player-specific code input by the player. After the player obtains the item acquisition information password, he/she returns to the game device 10 and inputs the password in accordance with game 70. The item acquisition information password is input, as shown in screen 75 for example, by writing a letter and mailing it in the virtual town. When this happens, a response letter is sent and arrives, as shown in screen 76. As shown in screen 77, it also becomes possible to play a different game (the old game, a mini-game, etc.) added as a present to what one already has.

Alternatively, if the player-specific code extracted from the item acquisition information does not match the player-specific code previously registered in the game machine 11, the special item cannot be acquired and an error message letter is displayed as shown in screen 78.

Furthermore, if the acquired item is a game that can be played on different hardware (a game for an old type of machine), it cannot be used as-is on the game device 10, so the CPU (not shown) of game device 10 uses an emulator program previously stored in storage unit 314 to execute acquired games for different game machines.

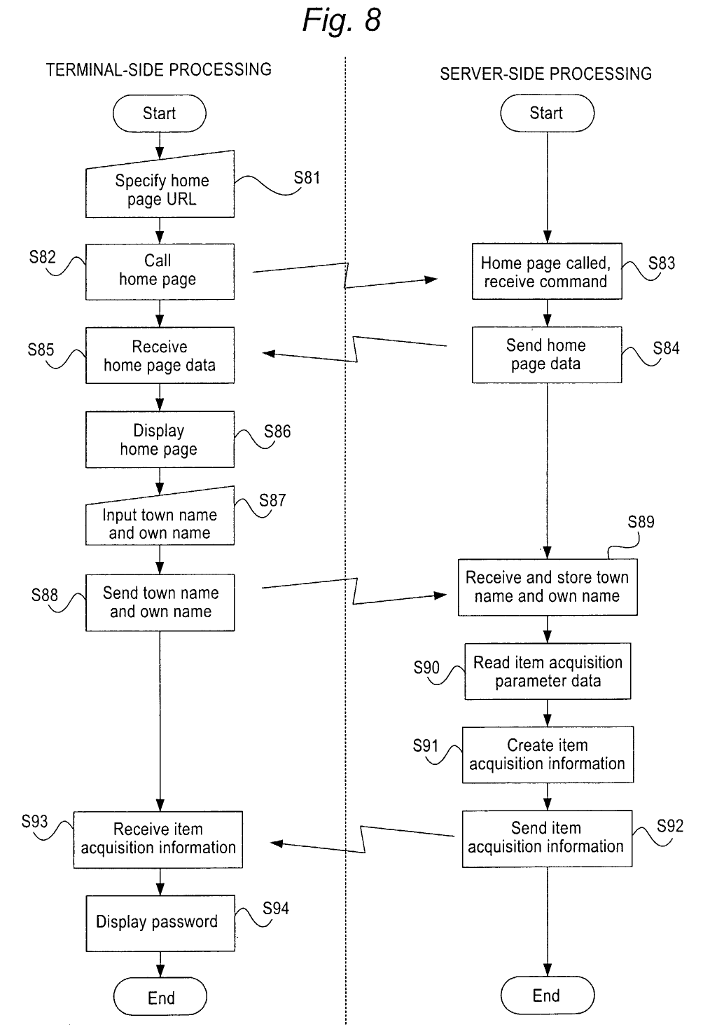

FIG. 8 is a flow chart explaining the specific operation of the item acquisition information generating device 20. In step (indicated by “S” in diagram) 81 the player operates the input device 22, specifying the address (URL) of the home page that is providing acquisition information for obtaining special item(s). In step 82, the terminal device 21 connects with server 24 via the Internet. In step 83, server 24 receives data sent from the terminal device 21. Subsequently, in step 84, server 24 sends image data to terminal device 21 to display the home page screen. Terminal device 21 receives the home page image data in step 85 and then displays an image based on the received image data on the display device 23 in step 86. In step 87, the player inputs the name of the virtual town in the game space where he is living and his own identity as an example of player-specific data.

In step 88, the player-specific data that has been input is sent to server 24. In step 89, server 24 receives the player-specific data and temporarily stores it in received data storage unit 43. Next, in step 90, server 24 reads the item acquisition parameter data stored in storage unit 42. In step 91, server 24 combines the item acquisition parameter data and the received player-specific data, creating the item acquisition information. In step 92, server 24 sends the item acquisition information to terminal device 21. In step 93, terminal device 21 receives the item acquisition information from server 24 and stores it in memory 21b. In step 94, the received item acquisition information is displayed on terminal device 23 as a password. The player retains the item acquisition information by remembering or writing down the displayed password.

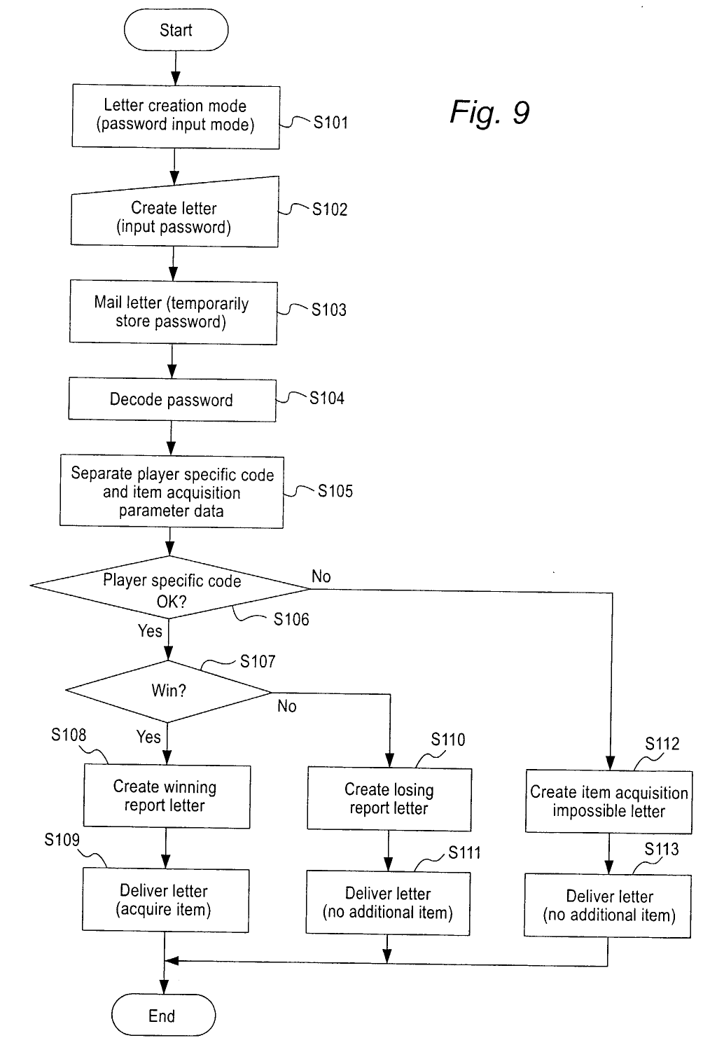

FIG. 9 illustrates processing by game device 10 after the item acquisition information (a password) is input. First, in step 101, the player selects a letter writing mode. This is a mode where the player's character in the game space can write letters to others living in the virtual town. In step 102, the acquired password is typed into the letter. In step 103, once the created letter is sent to the town post office, that password is stored in storage unit 321. In step 104, the password is decoded by CPU 16. In step 105, the decoding separates the player-specific code from the item acquisition parameter data (data on the type of special item and winning probability data).

In step 106, CPU 16 compares the player-specific code decoded from the password to the player-specific data registered by the player at the start of the game, to determine whether or not they satisfy the predetermined relationship. In step 107, CPU 16 then decides whether or not the player should be awarded an item, based on the winning probability data. In step 108, if CPU 16 decides the player has won, it creates a message that a special item has been awarded, based on the item acquisition parameter data. Then, in step 109, the letter is delivered to the player character's virtual home, notifying him that a special item has been awarded (he/she succeeded in acquiring the special item).

On the other hand, if CPU 16 decides the player did not win in preceding step 107, in step 110, a letter is created to the effect that he/she did not win. In step 111, that letter is delivered to the player character's home notifying him/her that the special item was not obtained, and the processing sequence ends.

Also, when it is decided in aforesaid step 106 that the predetermined relationship does not exist, in step 112, a letter is created to the player character, notifying him/her that the special item could not be acquired. In step 113, the letter is delivered to the player character's home, notifying him that the special item was not obtained, and the item acquisition processing sequence completes.

Entering a player-specific password obtained from a item acquisition generating device such as a homepage into a game device to gain access to special item(s) which are completely unavailable or difficult to obtain in primary (normal) game play may also be incorporated into a racing video game in accordance with the present invention.

Racing video games have been and continue to be very popular. There have been a variety of racing games that have been provided for use on video game consoles such as Nintendo's N64, GameCube and GameBoy Advanced, just to name a few. Numerous racing games involving cars, bicycles, airplanes, hovercrafts, spaceships, boats as well as many other vehicles, have been created over the years. Due in large part to advancements in graphics hardware, these racing games provide players with an exciting and enjoyable experience by simulating, for example, vehicle movement at very high speeds, various degrees of steering responsiveness, different racing tracks, and various obstacles (e.g., oil slicks, speed bumps, competing racing vehicles, etc.).

One currently available racing video game is “F-Zero: Maximum Velocity.” This game, which may be played for example using Nintendo's GameCube or GameBoy Advanced, allows the player from the outset of play to select one of three different racing track series (Pawn, Knight or Bishop) and then select from one of three different difficulty modes (Beginner, Standard or Expert). The game also allows a player to initially select from one of four different hovercrafts (Hot Violet, Fire Ball, J. B. Crystal, Windwalker) for use as that player's racing vehicle. Each of the different vehicles may have different operational characteristics. For example, the maximum normal speed, the maximum boosted speed (speed resulting from a temporary “turbo” boost of speed activated by game player input), boost time (how long a temporary boost will last), body strength, turn performance and turn balance may be different for each vehicle.

Additional racing track series (e.g., Queen), difficulty modes (e.g., Master) and vehicles (e.g., Sly Joker) may be “unlocked” once the player achieves certain goals with respect to the presently available tracks, difficulty modes and vehicles. For example, the vehicle Sly Joker is not available (i.e., is “locked” away) for play by a player when he/she initially begins playing the F-zero game. However, if the player wins all of the races in the initially available Pawn, Knight and Bishop-series of tracks on the standard difficulty mode, the Sly Joker vehicle becomes “unlocked” and is thereafter available for play by the player. As another example, the Queen series of tracks is unavailable for play by the player until the player can win all of the races in the Pawn, Knight and Bishop-series of tracks on the expert difficulty mode. The progress (e.g., what races the player has won) made by each player who plays the F-zero game may be stored in, for example, a nonvolatile memory in the game cartridge or game console or in an external memory (e.g., memory card 15 illustrated in FIG. 1A) connected to the console so that the player may avoid having to replicate past efforts and thus effectively start at the point where he/she left when restarting the game.

Additional vehicles (e.g., Stingray, Silver Thunder, Falcon MK-II, Fighting Comet), each with different operational characteristics, become successively unlocked as the player achieves higher and higher goals (the requirements for each goal surpassing the previous) until the last vehicle, Jet Vermilion, is unlocked and made available for play. The Jet Vermilion vehicle may have enhanced characteristics such as the fastest maximum boosted speed and/or the highest body strength among all possible vehicles.

However, some players will not be able to achieve the goals (in normal primary game play) required to unlock the Jet Vermilion or other vehicles initially locked at the outset of play. These same players may still want to enjoy playing with Jet Vermilion to experience its enhanced operational characteristics. Others who may ultimately achieve the goals required to unlock the Jet Vermilion may want to begin to play with it immediately. There is thus a desire felt among many players to be able to immediately play with the Jet Vermilion and/or other initially locked vehicles (and/or initially locked racing track(s) or difficulty mode(s)) without being forced to achieve the goals required to unlock them.

Accordingly, the present invention satisfies this desire by incorporating the “homepage password feature” (described above in the context of the role playing video game of FIG. 7) in which a player-specific password obtained from a item acquisition generating device (such as via a homepage generated from device 20) is entered into a game device to gain access to special item(s) which are completely unavailable or difficult to obtain in normal primary game play into the F-Zero: Maximum Velocity video game. That is, if input provided by the player satisfies the password feature described above, immediate access to the Jet Vermilion vehicle and/or other previously locked vehicles, racing track-series or difficulty modes may be granted for play by the player.

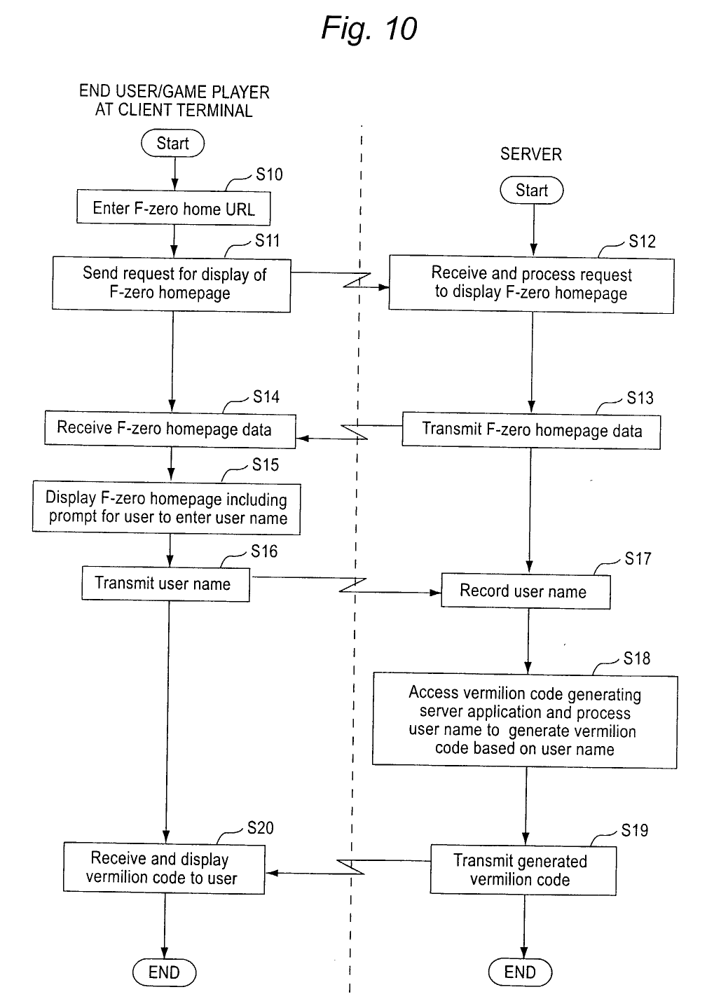

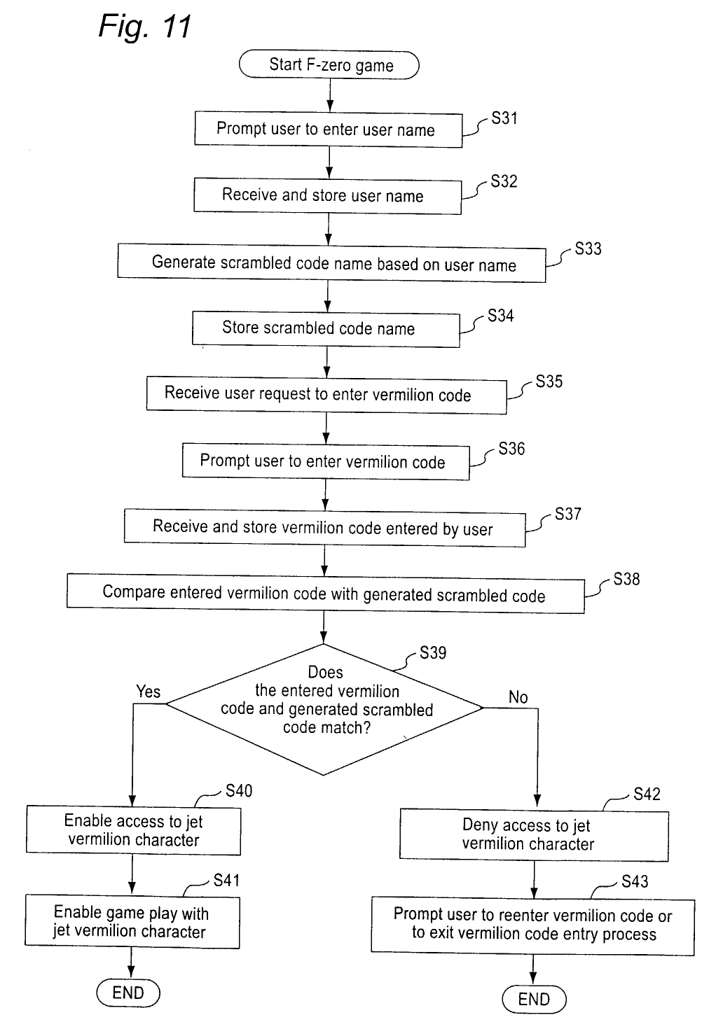

In addition to implementing the homepage password feature discussed above into a racing videogame such as F-zero, FIGS. 10 and 11 illustrate another embodiment of the present invention in the context of the F-Zero video game. Referring first to FIG. 10, a user may access a homepage dedicated to the F-zero videogame by inputting the appropriate website uniform resource locator (URL) (step S10). A browser operated on the user's computer terminal transmits a request to display the F-zero homepage to a server running the F-zero homepage application (step S11). The server then transmits homepage data to the user terminal to enable display of the F-zero homepage (steps S13-15). The homepage includes an input prompt for the user to enter his/her user name. For example, a first user may enter his user name “HIRO” and a second user may enter her own user name “ACHI.”

After receiving the user name, the server will record the user name and access an application which will generate item acquisition information (e.g., a password hereinafter referred to as a “vermilion code”) based on that user name (steps S16-17). The vermilion code is then transmitted to the user for display (steps S19-S20). If another player enters a different user name, the vermilion code generated by the server application will be different than the vermilion code generated for the first player. Each player may thus have his/her own unique vermilion code provided his/her user name is unique. That is, the vermillion code is user-specific.

The password generated by the server application is referred to as the “vermilion code” since this password may be later used to unlock the Jet Vermilion vehicle character as will be discussed below. However, it will be understood that other passwords may be generated by the server application based on the user's name and item acquisition parameter data which can later be used to unlock other respective vehicles, racing track series or modes of difficulty. For example, the server application may generate and output to the user a password to unlock the Queen-series of racing tracks or the Master-mode of difficulty based on the user name entered in the F-zero homepage.

FIG. 11 describes the user's play of the F-zero video game. When a user begins to play the F-Zero game (or at some other time during game play), he/she is prompted to enter his/her user name (step 31). The user may enter his/her user name through operation of the control buttons, switches, etc. on the game console or controller 12 connected to thereto. The software of the F-Zero game stores the entered user name and generates a scrambled password code based on the entered user name (steps 32-33). This scrambled password code is generated by the F-zero software game in the same manner in which the server application of the F-zero webpage generates a vermilion code. That is, the scrambled password code generated by the software of the F-zero game and the vermilion code generated by the server application of the F-zero webpage will match if the user name input to both is the same. The scrambled password code generated by the software of the F-zero game may then be stored in a memory such as, for example, the RAM of the game console (step 34). The software of the F-zero game is also capable of generating other password codes for other respective racing vehicles, racing track series and/or mode(s) of difficulty based on the user name input at the start of play of the F-zero game.

When the user later desires to play with the Jet Vermilion vehicle (presuming that the Jet Vermilion has not already been unlocked via normal primary play), he/she may input the required command to request a prompt for entry of the vermilion code (step 35). At the prompt, the user may then input the vermilion code previously obtained from the F-Zero webpage (step 37). The command to obtain the input prompt and the vermilion code may be entered using the control switches, buttons, etc. If the vermilion code entered by the user matches the scrambled password code generated by the software program (based on the user name input when the game is started), then immediate access to the Jet Vermilion vehicle is granted for play by the user (steps 39-41). Otherwise, access to the Jet Vermillion character is denied and the user has the option of re-entering the vermilion code or exit the vermilion code entry process (steps 42-43).

Instead of the vermilion code entry process described above, the user may alternatively enter the appropriate command to request the prompt for entering a password corresponding to any of these other locked vehicles, racing track-series or modes of difficulty. The entered password (previously obtained by the user from the item acquisition information generating device running the F-zero webpage based on the user name input therein) is then compared to the appropriate password code generated by the software of the F-zero game based on the user name previously entered in the F-zero game to determine whether to grant immediate access to the desired vehicle, racing track series or mode of difficulty.

Suppose a second user “ACHI” tells a first user “HIRO” the vermilion code that she received from the F-Zero webpage as a result of inputting her user name “ACHI” and that the first user then starts the F-Zero game by inputting his code name “HIRO”. The F-Zero software generates a scrambled password code based on the input user name “HIRO.” If the first user then correctly inputs the vermilion code received based on the code name “ACHI” (i.e., the vermilion code that was given to the first user “HIRO” by the second user “ACHI”) into the F-Zero game, the access to the Jet Vermilion vehicle will be denied since the vermilion code (based on the user name “ACHI” entered into the F-zero webpage) entered into the F-Zero game will not match the scrambled password code (based on the user name “HIRO” input at the start of the game play) generated by the software program of the F-Zero game.

Like the role playing game discussed above in FIG. 7, the homepage password feature of the F-Zero game therefore has a “player-checking” capability. That is, access to the locked feature (in the foregoing example, the Jet Vermilion) will be denied if a user inputs the unique password (in the foregoing example, the vermilion code) assigned to another user (i.e., a user having a different user name) by the F-Zero webpage. Access will only be granted in the player correctly inputs his/her own password. As an example, if the first user “HIRO” in the above example were to have entered his own vermilion code (i.e., the vermilion code output from the server application of the F-zero webpage based on the user name “HIRO”), then the entered vermilion code would have successfully matched the scrambled password code generated by the software of the F-Zero game (also based on the user name “HIRO” entered at the start of play) and stored in the console memory for access to the Jet Vermilion.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A game system capable of play based on item acquisition information, the game system comprising:
a game device including a controller operated by a player, a data storage memory, a game processor, and a display for displaying a screen according to image data processed by the game processor, and
an item acquisition information generating device provided separately from the game device for generating item acquisition information in accordance with player operation; the data storage memory of the game device comprising:
a player-specific data storage unit for storing data specifying a relevant player when said controller is operated in a predetermined operational sequence by a player,
a storage unit for storing said item acquisition information,
a decoding program storage unit for storing a decoding program for decoding said item acquisition information,
a game program storage unit for storing a game program, and
a comparison program storage unit for storing a comparison program;
said item acquisition information generating device comprising:
an input device for inputting said player-specific data according to player operation, and
item acquisition information creating device for creating item acquisition information and reporting it to the player, based on player-specific data input by said input device and item acquisition parameter data,
the game processor of the game device:
storing item acquisition information in a storage memory based on said game program when item acquisition information is input by operation of said controller,
processing the item acquisition information stored in said storage memory based on said decoding program and decoding it to player-specific data and data other than player-specific data,
comparing and checking player-specific data stored in said player-specific data storage unit and decoded player-specific data based on said comparison program, and
processing, so as to allow acquisition of a special item associated with said item acquisition information when executing said game program, based on the data other than said decoded player-specific data, when the result of said comparison and checking satisfies a predetermined relationship.

2. A game system capable of play based on item acquisition information according to claim 1, wherein said item acquisition information generating device comprises a server installed in a place separated from a terminal device operated by a player and connected to the terminal device via a communication circuit;
said server:
temporarily storing the relevant player-specific data in a second temporary storage memory when said player-specific data is input into said input device installed in said terminal device, and
sending the relevant item acquisition information to said terminal device and reporting it to the player at the terminal device after said item acquisition information creating device creates the item acquisition information based on player-specific data stored in the second temporary storage memory and set item acquisition parameter data.

3. A game system capable of play based on item acquisition information according to claim 1, wherein said item acquisition information generating device additionally comprises an external information storage medium associatively provided near said game device, a data reader for reading data recorded or stored on the external information storage medium, and a display;
said external information storage medium recording or storing said item acquisition parameter data; and
said item acquisition information creating device creating item acquisition information based on player-specific data stored in a second temporary storage memory and item acquisition parameter data read from said external information storage medium by said data reader and reporting it to a player by displaying it on said display.

4. A game system capable of play based on item acquisition information according to claim 1, wherein said item acquisition information creating device creates the item acquisition information using preset item award probability data as the item acquisition parameter data.

5. A game system capable of play based on item acquisition information according to claim 4, wherein the item award probability data is preset for each type of a plurality of special items, and said item acquisition information creating device creates item acquisition information that includes the type of special item awarded and award probability data.

6. A game system capable of play based on item acquisition information according to claim 1, wherein said game program storage unit stores at least data on a plurality of types of items that can be acquired in primary game play and data on at least one special item that cannot be acquired only in primary game play and that is set so that acquisition is possible based on said item acquisition information, and stores a preset game program that plays a game using these plurality of items, and
said item acquisition information creating device creates data for awarding special items that cannot be acquired in primary game play and realized by said game program as item acquisition information.

7. A game system capable of play based on item acquisition information according to claim 6, wherein the game program stored in said game program storage unit is programmed so that special item acquisition does not affect the primary game's game play parameters.

8. A method of enabling user access to an item for play in a video game being processed by a game device, the method comprising:
receiving an on-line input of a user code in a computer system;
generating a user-specific password based on the received user code utilizing the computer system;
reporting the user-specific password utilizing the computer system;
receiving, in the game device, an input of a user code;
receiving, in the game device, an input of the user-specific password;
processing the user code received in the game device and the user-specific password received in the game device;
comparing data resulting from the processing of the user code received in the game device and data resulting from the processing of the user-specific password received in the game device; and
enabling user access to the item for play in the video game if the data resulting from the processing of the user code received in the game device and the data resulting from the processing of the user-specific password received in the game device satisfy a predetermined relationship.

9. The method of claim 8 wherein processing the user-specific password received in the game device includes decoding the user-specific password to user code data and data other than user code data, the decoded user code data forming the data to be compared to the data resulting from the processing of the user code received in the game device.

10. The method of claim 8 wherein processing the user code received in the game device includes generating code data based on the user code received in the game device, the generated code data forming the data to be compared to the data resulting from the processing of the user-specific password received in the game device.

11. The method of claim 10 wherein a process for generating the user-specific password based on the on-line input of the user code in the computer system corresponds to a process for processing the user code received in the game device so that the predetermined relationship will be satisfied if the user code received on-line in the computer system is the same as the user code received in the game device.

12. The method of claim 8 wherein the user-specific password generated by the computer system includes user code data and item award probability data.

13. The method of claim 8 wherein the video game is a racing video game and the item is at least one of a particular racing vehicle, difficulty mode and racing track.

14. The method of claim 8 wherein the predetermined relationship is satisfied only if the user code input on-line, which is used by the computer system to generate the user-specific password received by the game device, matches the user code received by the game device.

15. A system for enabling user access to an item for play in a video game, the system comprising:
a computer system which receives an on-line input of a user code, generates a user-specific password based on the received user code, and reports the user-specific password; and
a game device which processes the video game, receives an input of a user code and an input of the user-specific password, processes the user code received in the game device and the user-specific password received in the game device, compares data resulting from the processing of the user code received in the game device and data resulting from the processing of the user-specific password received in the game device, and enables user access to the item for play if the data resulting from the processing of the user code received in the game device and the data resulting from the processing of the user-specific password received in the game device satisfy a predetermined relationship.

16. The system of claim 15 wherein processing the user-specific password received in the game device includes decoding the user-specific password to user code data and data other than user code data, the decoded user code data forming the data to be compared to the data resulting from the processing of the user code received in the game device.

17. The system of claim 15 wherein processing the user code received in the game device includes generating code data based on the user code received in the game device, the generated code data forming the data to be compared to the data resulting from the processing of the user-specific password received in the game device.

18. The system of claim 17 wherein a process for generating the user-specific password based on the on-line input of the user code in the computer system corresponds to a process for processing an input of the user code received in the game device so that the data relating to the user-specific password will match the generated code data if the user code received on-line in the computer system is the same as the user code received in the game device.

19. The system of claim 15 wherein the computer system comprises a server which receives the on-line input of the user code from a remote terminal via a communication circuit and reports the user-specific password to a user by providing the user-specific password to the terminal via the communication circuit.

20. The system of claim 15 wherein the user-specific password generated by the computer system includes user code data and item award probability data.

21. The system of claim 15 wherein a computer software program run by the computer system to generate the user-specific password based on the on-line input of the user code received by the computer system and a computer software program run by the game device to process the user code received by the game device correspond to each other such that data resulting from the processing of the user-specific password received in the game device and the data resulting from the processing of the user code received in the game device satisfy the predetermined relationship if the code name received on-line in the computer system is the same as the code name received in the game device.

22. The system of claim 15 wherein the video game is a racing video game and the item is at least one of a particular racing vehicle, difficulty mode and racing track.
